(19) United States
(12) Patent Application Publication
(10) Pub. No.: US 2013/0036331 A1
(43) Pub. Date: Feb. 7, 2013

(54) DEBUGGING METHOD AND DEBUGGING DEVICE

(71) Applicant: Huawei Technologies Co., Ltd., Shenzhen (CN)

(72) Inventors: Dacheng ZHANG, Beijing (CN); Yichao LI, Shenzhen (CN); Dan LIU, Shenzhen (CN); Qinyuan CHEN, Shenzhen (CN); Zepeng LIU, Shenzhen (CN); Bingxue QIU, Shenzhen (CN)

(73) Assignee: HUAWEI TECHNOLOGIES CO., LTD., Shenzhen (CN)

(21) Appl. No.: 13/647,190

(22) Filed: Oct. 8, 2012

Related U.S. Application Data
(63) Continuation of application No. PCT/CN2010/079643, filed on Dec. 10, 2010.

(30) Foreign Application Priority Data
Apr. 6, 2010 (CN) 201010142081.0

(51) Int. Cl. G06F 11/36

(52) U.S. Cl. 714/38.13; 714/E11.02; 714/E11.208

(57) ABSTRACT

A debugging method includes: modifying a fault handling function address corresponding to a page attribute fault in an interrupt descriptor table of a system processor to a user-defined fault handling function address; obtaining current information when a designated page attribute fault occurs in a target program; storing the current information into a virtual execution buffer corresponding to a current thread; pushing the current information in the buffer into a stack; determining whether an extended instruction pointer of the target program matches a preset breakpoint address of a faulty page; if the matching succeeds, interacting with a user; otherwise, copy-constructing an instruction, pointed to by the extended instruction pointer of the target program, to the virtual execution buffer corresponding to the current thread; and popping the current information out of the stack, executing the instruction in the buffer, and repeating the determination about whether the address matches the preset breakpoint address.

### CROSS-REFERENCE TO RELATED APPLICATIONS

This application is a continuation of International Patent Application No. PCT/CN2010/079643, filed on Dec. 10, 2010, which claims priority to Chinese Patent Application No. 201010142081.0, filed on Apr. 6, 2010 both of which are hereby incorporated by reference in their entireties.

### FIELD OF THE DISCLOSURE

The present disclosure relates to the field of computer technologies, and in particular, to a debugging method and a debugging device.

### BACKGROUND OF THE DISCLOSURE

The debugging technology is widely applied to code analysis, reverse engineering, and analysis on malicious codes. Software debugging includes: setting a breakpoint in an execution path of a target program to cause the execution to stop at the breakpoint; performing single-step tracking for the target program; and providing rich information generated when the target program runs.

During the research and practice of the prior art, the inventor of the present disclosure finds that a common debugging method in the prior art is to implement a breakpoint mechanism by modifying codes of the target program, and therefore, an anti-debugging technology can easily discover the modified codes and recover the target program. The existing debugging method is weak in covertness.

### SUMMARY OF THE DISCLOSURE

Embodiments of the present disclosure provide a debugging method and a debugging device to debug a target program covertly without modifying codes of the target program.

An embodiment of the present disclosure provides a debugging method, including:
modifying a fault handling function address corresponding to a page attribute fault in an interrupt descriptor table of a system processor, to a user-defined fault handling function address;
obtaining current information of a target program when a designated page attribute fault occurs in the target program;
storing the obtained current information into a virtual execution buffer corresponding to a current thread;
pushing the current information in the virtual execution buffer into a stack;
determining whether an extended instruction pointer of the target program matches a preset breakpoint address of a faulty page;
if the matching succeeds, interacting with a user;
otherwise, copy-constructing an instruction, pointed to by the extended instruction pointer of the target program, to the virtual execution buffer corresponding to the current thread; and
popping the current information out of the stack, executing the instruction in the virtual execution buffer, and repeating the determination about whether the extended instruction pointer of the target program matches the preset breakpoint address.

An embodiment of the present disclosure provides a debugging device, including:
a first modifying module, configured to modify a fault handling function address corresponding to a page attribute fault in an interrupt descriptor table of a system processor to a user-defined fault handling function address;
an obtaining module, configured to obtain current information of a target program when a designated page attribute fault occurs in the target program;
a first storing module, configured to store the obtained current information into a virtual execution buffer corresponding to a current thread;
a second storing module, configured to push the current information in the virtual execution buffer corresponding to the current thread into a stack;
a first determining module, configured to: determine whether an extended instruction pointer of the target program matches a preset breakpoint address of a faulty page; if the matching succeeds, trigger an interacting module to perform relevant operations; otherwise, trigger a copying module to perform relevant operations;
the interacting module, configured to interact with a user;
the copying module, configured to copy-construct an instruction, pointed to by the extended instruction pointer of the target program, to the virtual execution buffer; and
an executing module, configured to pop the current information out of the stack, execute the instruction in the virtual execution buffer, and trigger the first determining module to perform relevant operations.

The foregoing technical solutions show that the embodiments of the present disclosure bring the following benefits:

In the embodiments of the present disclosure, the fault handling function address corresponding to the page attribute fault is modified so that the debugging device can capture the right of controlling the target program when the page attribute fault occurs in the target program; after capturing the control right, the debugging device stores the current information into the buffer corresponding to the current thread and pushes the current information into the stack, and then copy-constructs and executes the instruction of the target program; therefore, when the target program runs to the preset breakpoint location, the system interacts with the user, and the user debugs the target program. In this way, the user debugs the target program covertly without modifying the codes of the target program.

### BRIEF DESCRIPTION OF THE DRAWINGS

FIG. 1 is a schematic diagram of an embodiment of a debugging method according to an embodiment of the present disclosure;

FIG. 2 is a schematic diagram of another embodiment of a debugging method according to an embodiment of the present disclosure;

FIG. 3 is a schematic diagram of a multi-processor procedure in another embodiment of a debugging method according to an embodiment of the present disclosure;

FIG. 4 is a schematic diagram of a multi-thread procedure in another embodiment of a debugging method according to an embodiment of the present disclosure;

FIG. 5 is a schematic diagram of a single-step handling procedure in another embodiment of a debugging method according to an embodiment of the present disclosure;

FIG. 6 is a schematic diagram of an anti structured exception handling procedure in another embodiment of a debugging method according to an embodiment of the present disclosure;

FIG. 7 is a schematic diagram of an embodiment of a debugging device according to an embodiment of the present disclosure; and

FIG. 8 is a schematic diagram of another embodiment of a debugging device according to an embodiment of the present disclosure.

### DETAILED DESCRIPTION OF THE EMBODIMENTS

Embodiments of the present disclosure provide a debugging method and a debugging device, which are detailed below.

When a page attribute fault occurs, a target program will jump to execute a fault handling function corresponding to the page attribute fault in an interrupt descriptor table (IDT, Interrupt Descriptor Table) of a processor. Therefore, in the embodiments of the present disclosure, a debugging location expected by a user is used as a preset breakpoint address, a page attribute of a page of the address is modified, and the fault handling function corresponding to the page attribute fault in the IDT of the processor is modified to a user-defined fault handling function address, so that when the target program runs to the page of the address, the page attribute fault occurs, and the target program jumps to execute the user-defined fault handling function. In this way, the debugging device captures the right of controlling the target program. After the control right is captured, the current information is stored into a buffer corresponding to a current thread, and pushed into a stack, and then the target program is executed one by one through a virtual execution technology. When the target program runs to a preset breakpoint location, the system interacts with the user, and the user debugs the target program. In this way, the user debugs the target program without modifying codes of the target program.

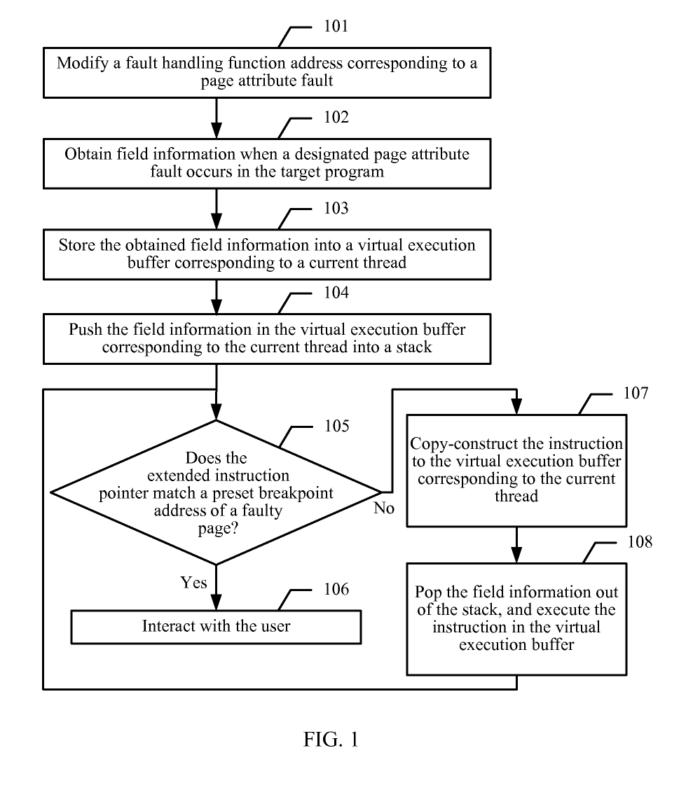

As shown in FIG. 1, an embodiment of a debugging method in an embodiment of the present disclosure includes the following:

101. Modify a fault handling function address corresponding to a page attribute fault in an interrupt descriptor table of a system processor to a user-defined fault handling function address.

In this embodiment of the present disclosure, a page attribute of a page of a preset breakpoint is modified beforehand, and the page attribute fault occurs when a target program accesses the page of the preset breakpoint. To enable a debugging device to obtain the control right when the target program accesses the page of the breakpoint, it is necessary to modify the fault handling function address corresponding to the page attribute fault in the IDT of the system processor to the user-defined fault handling function address.

When the system has only one processor, it is only necessary to modify the fault handling function address corresponding to the page attribute fault in the IDT of this processor to the user-defined fault handling function address.

In a multi-processor environment, each processor has its own IDT. Therefore, it is necessary to modify the fault handling function address corresponding to the page attribute fault in the IDT of each processor of the system to the user-defined fault handling function address.

102. Obtain current information of the target program when a designated page attribute fault occurs in the target program.

The page attribute of the page of the preset breakpoint to be debugged is modified beforehand, and therefore, a page attribute fault will occur when the target program runs to this page.

The page attribute fault comes in many types, for example, page fault and access fault. When a page attribute fault occurs, the target program executes a user-defined fault handling function, namely, performs steps 102 to 107, so that the debugging device captures the right of controlling the target program.

The page fault occurs frequently in the system. Therefore, it may be specified that the user-defined fault handling function is not executed unless an access fault occurs in the target program.

At the same time of obtaining the current information of the target program, a preset breakpoint address of a faulty page of the target program may be obtained.

103. Store the obtained current information into a virtual execution buffer corresponding to a current thread.

In a single-thread environment, a corresponding virtual execution buffer may be created for a thread in a memory, and the obtained current information is stored directly into the virtual execution buffer corresponding to the current thread.

In a multi-thread environment, because the current information is thread-related, a corresponding virtual execution buffer needs to be created for each thread whose control right is captured, where the buffer serves to store the current information when a fault occurs. Therefore, in a multi-thread environment, after step 102 is performed and before step 103 is performed, it is determined whether a virtual execution buffer corresponding to the current thread exists; if the buffer does not exist, a virtual execution buffer corresponding to the current thread is created, and step 103 is triggered; while if the buffer exists, step 103 is triggered.

104. Push the current information in the virtual execution buffer corresponding to the current thread into a stack.

From step 103 to step 104, the system changes from a kernel state to a user state.

105. Determine whether an extended instruction pointer (EIP, Extended Instruction Pointer) of the target program matches the preset breakpoint address of the faulty page; if so, go to step 106; and if not, go to step 107.

The EIP of the target program is the address of the next instruction of the target program to be executed.

In this embodiment of the present disclosure, page attributes of multiple pages may be modified, breakpoint addresses are configured on multiple pages, and a table may store the mapping relationship between the pages with modified page attributes and the preset breakpoint addresses. It is appropriate to determine whether the address of the EIP of the target program matches the preset breakpoint address of the page where a page attribute fault occurs in the table.

Alternatively, at the same time of obtaining the current information in step 102, it is appropriate to obtain the preset breakpoint address of the page where the page attribute fault occurs; and, at the same time of storing the current information in step 103, the obtained preset breakpoint address is stored into the virtual execution buffer corresponding to the current thread. In this case, step 105 is to determine whether the EIP of the target program matches the preset breakpoint address in the buffer.

106. Interact with a user.

Interact with the user so that the user debugs the target program. The interaction process is well known in the prior art, and is not detailed herein.

107. Copy-construct an instruction, pointed to by the extended instruction pointer of the target program, to the virtual execution buffer corresponding to the current thread.

If the determination result in step 105 is negative, copy-construct the instruction pointed to by the EIP of the target program, write the result of the copy-construction into the virtual execution buffer corresponding to the current thread, and execute the instruction in the buffer so that the target program is executed virtually at a single step. Afterward, repeat step 105 until the target program runs to a preset breakpoint location of the page where a page attribute fault occurs.

108. Pop the current information out of the stack, execute the instruction in the virtual execution buffer, and repeat step 105.

In this embodiment, the fault handling function address corresponding to the page attribute fault is modified so that the debugging device can capture the right of controlling the target program when the page attribute fault occurs in the target program; after capturing the control right, the debugging device stores the current information into the buffer corresponding to the current thread and pushes the current information into the stack, and then copy-constructs and executes the instruction of the target program; therefore, when the target program runs to the preset breakpoint location, the system interacts with the user, and the user debugs the target program. In this way, the user debugs the target program covertly without modifying the codes of the target program.

It should be noted that, when the instruction executed in step 108 is a jump instruction, the EIP of the target program may go beyond the page range where the page attribute fault occurs. Consequently, in step 105, the EIP always does not match the preset breakpoint address of the page where the page attribute fault occurs, and the instruction pointed to by the EIP of the target program keeps being copy-constructed and executed. An embodiment is provided to tackle such a problem.

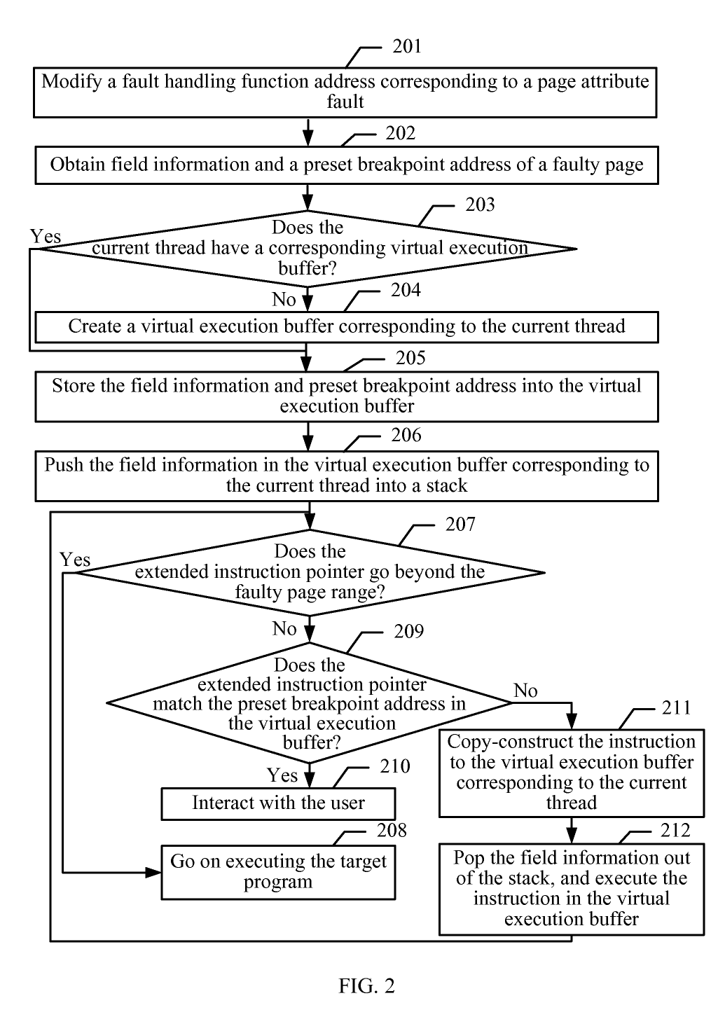

As shown in FIG. 2, another embodiment of a debugging method of the present disclosure includes the following:

201. Modify a fault handling function address corresponding to a page attribute fault in an interrupt descriptor table of a system processor to a user-defined fault handling function address.

For details of step 201, see the description about step 101.

202. When a designated page attribute fault occurs in a target program, obtain current information of the target program and a preset breakpoint address of a faulty page.

The preset breakpoint address of the faulty page may be obtained in a table storing the mapping relationship between the page and the preset breakpoint address.

The fault mentioned in this embodiment refers to the page attribute fault that occurs in the target program.

203. Determine whether a virtual execution buffer corresponding to a current thread exists; if the buffer does not exist, go to step 204; and if the buffer exists, go to step 205.

204. Create a virtual execution buffer corresponding to the current thread, and trigger step 205.

205. Store the obtained current information and preset breakpoint address into the virtual execution buffer corresponding to the current thread.

206. Push the current information in the virtual execution buffer corresponding to the current thread into a stack.

From step 205 to step 206, the system changes from a kernel state to a user state.

207. Determine whether an extended instruction pointer of the target program goes beyond a faulty page range; if so, go to step 208; and if not, go to step 209.

208. Go on executing the target program.

Pop the current information out of the stack and go on executing the target program.

209. Determine whether the extended instruction pointer of the target program matches the preset breakpoint address in the virtual execution buffer corresponding to the current thread; if so, go to step 210; and if not, go to step 211.

The preset breakpoint address in the virtual execution buffer corresponding to the current thread is the preset breakpoint address of the faulty page.

210. Interact with a user.

211. Copy-construct an instruction, pointed to by the extended instruction pointer of the target program, to the virtual execution buffer corresponding to the current thread.

212. Pop the current information out of the stack, execute the instruction in the virtual execution buffer corresponding to the current thread, and repeat step 207.

In this embodiment, if it is determined that the EIP of the target program does not go beyond the faulty page range, a determination is made about whether the EIP of the target program matches the preset breakpoint address in the virtual execution buffer corresponding to the current thread; and if the matching succeeds, the system interacts with the user, which avoids the problem that the EIP always does not match the preset breakpoint address of the page where the page attribute fault occurs.

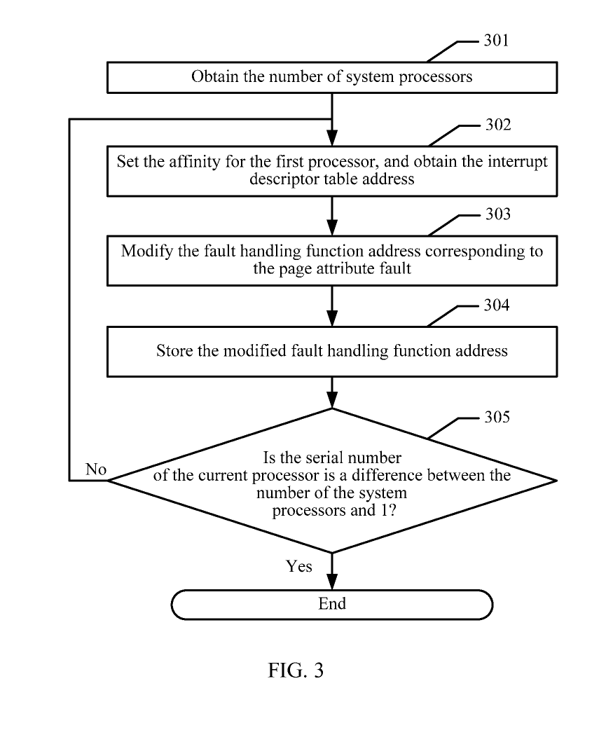

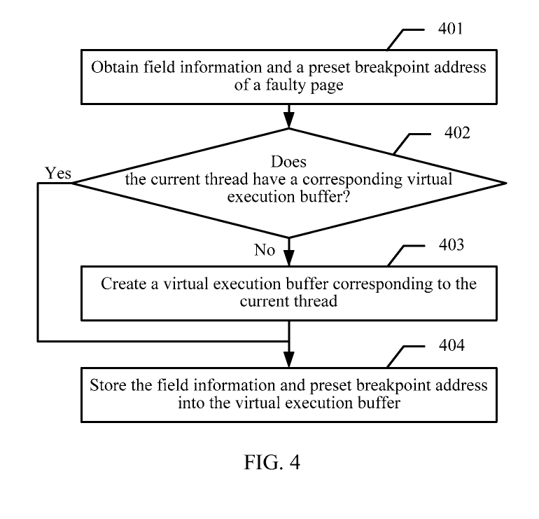

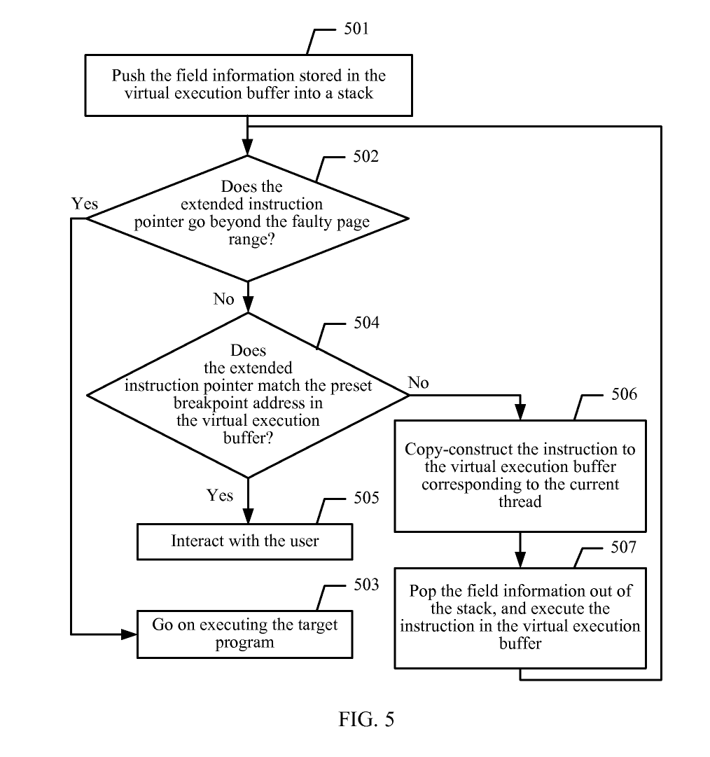

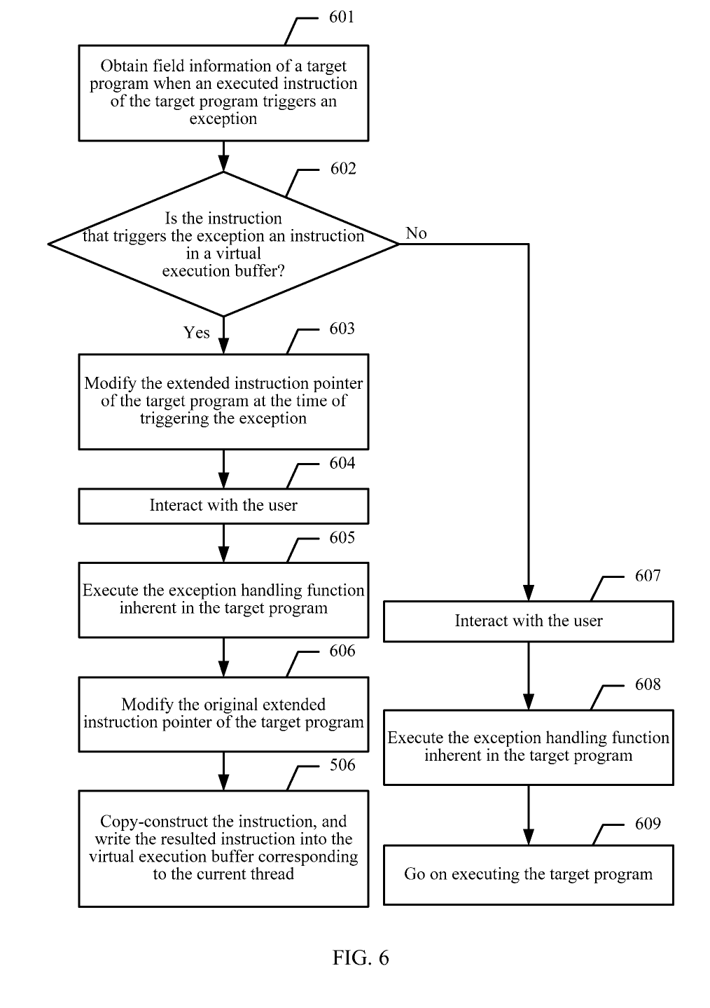

To facilitate understanding, the following gives more details about a debugging method according to an embodiment of the present disclosure with reference to FIG. 3, FIG. 4, FIG. 5 and FIG. 6. For ease of description, the debugging method in this embodiment is described in four parts. The four parts are a multi-processor procedure, a multi-thread procedure, a single-step handling procedure, and an anti structured exception handling (SEH, Structured Exception Handling) procedure respectively.

As shown in FIG. 3, a multi-processor procedure in another embodiment of a debugging method of the present disclosure includes the following:

301. Obtain the number of system processors.

The system processor ID counts from 0. If the system has 4 processors in total, the IDs of the four processors are 0, 1, 2, and 3, respectively.

302. Set the target program's affinity for a first processor of the system, and obtain an interrupt descriptor table address of the processor.

The ID of the first processor is 0.

303. Modify a fault handling function address corresponding to a page attribute fault in the interrupt descriptor table of the first processor to a user-defined fault handling function address.

304. Corresponding to the processor, store the fault handling function address modified in step 303.

The step of modifying the fault handling function address corresponding to the page attribute fault in the IDT of the processor to the user-defined fault handling function address is applicable not only to the target program, but also to any program that runs under the processor. Therefore, corresponding to the processor, the modified fault handling function address inherent in the system may be stored, so that programs other than the target program can be handled by the fault handling function inherent in the system when the page attribute fault occurs.

305. Determine whether the serial number of the current processor is a difference between the number of the system processors and 1; if not, go to step 302 to set the target program's affinity for the next processor of the system; and if so, terminate the operation.

In the first cycle, the current processor is the first processor, and its ID is 0. Therefore, after step 305 is performed, step 302 is repeated to set the target program's affinity for a second processor (whose ID is 1) in the system.

When a designated page attribute fault occurs in the target program, the debugging device obtains the control right, namely, runs the user-defined fault handling function. The function includes a multi-thread procedure.

Because the debugging device modifies the page attribute of the page of the breakpoint, all operations of accessing the instructions on the page are interrupted. The single-step handling procedure requires constructing a virtual execution buffer to store the current information when a page fault occurs. The current information is thread-related. Therefore, before the single-step handling procedure, it is necessary to construct a virtual execution buffer for every thread whose control right is captured, where the buffer serves to store the current information when the fault occurs.

As shown in FIG. 4, a multi-thread procedure in another embodiment of a debugging method of the present disclosure includes the following:

401. When a designated page attribute fault occurs in a target program, obtain current information of the target program and a preset breakpoint address of a faulty page.

402. Determine whether a virtual execution buffer corresponding to a current thread exists; if the buffer does not exist, go to step 403; and if the buffer exists, go to step 404.

403. Create a virtual execution buffer corresponding to the current thread, and trigger step 404.

404. Store the obtained current information and preset breakpoint address into the virtual execution buffer corresponding to the current thread.

The multi-thread procedure is executed in a kernel state of the system. The multi-thread procedure stores the current information into the buffer of the current thread, and then a single-step handling procedure is initiated for processing. In this way, multiple threads are executed virtually in parallel at a single step, which avoids interference between the threads and implements covert debugging in a multi-thread environment.

After the multi-thread procedure is executed in the kernel state, the single-step handling procedure is executed in a user state.

As shown in FIG. 5, a single-step handling procedure in another embodiment of a debugging method of the present disclosure includes the following:

501. Push the current information, stored into the virtual execution buffer in step 404, into a stack.

502. Determine whether an extended instruction pointer of the target program goes beyond a faulty page range; if so, go to step 503; and if not, go to step 504.

If the EIP of the target program goes beyond the faulty page range in step 401, go to step 503, and hand the control right over to the target program; and if not, go to step 504 to determine whether the EIP of the target program is a breakpoint.

503. Go on executing the target program.

504. Determine whether the extended instruction pointer of the target program matches the preset breakpoint address stored in the virtual execution buffer corresponding to the current thread in step 404; if so, go to step 505; and if not, go to step 506.

505. Interact with a user.

If the determination result in step 504 is positive, interact with the user, and let the user debug the target program.

506. Copy-construct an instruction pointed to by the extended instruction pointer of the target program, and write the result of the copy-construction into the virtual execution buffer corresponding to the current thread.

507. Pop the current information out of the stack, execute the instruction that is written into the virtual execution buffer corresponding to the current thread in step 506, and repeat step 502.

The single-step handling procedure uses a technology of copy-constructing codes to execute the target program virtually one by one.

In the prior art, an anti-debugging SEH technology exists. In a system based on such a technology, when specific codes of the target program are exceptional, the system invokes an exception dispatch (Ki User Exception Dispatch) function to handle the exception. Therefore, copy-constructing and virtually executing a target program that uses the anti SEH technology to jump abnormally may cause the single-step handling procedure to jump out of the normal execution procedure, which causes the debugging device to lose the right of controlling the target program.

To ensure continuous and stable monitoring and debugging for the target program, the exception dispatch function needs to be captured when the virtual execution of the single-step handling procedure is exceptional, and certain operations need to be performed as required to keep the debugging device's right of controlling the target program. Therefore, in this embodiment of the present disclosure, the exception dispatch function inherent in the system is modified to a user-defined exception dispatch function, and the function is the anti SEH procedure.

As shown in FIG. 6, an anti SEH procedure in another embodiment of a debugging method of the present disclosure includes the following:

601. Obtain current information of a target program when an executed instruction of the target program triggers an exception.

602. Determine whether the instruction that triggers the exception is an instruction in a virtual execution buffer; if so, go to step 603; and if not, go to step 607.

A virtual execution flag bit may be set. At the time of executing a single-step handling procedure, the flag bit is set to 1; while at the time of executing the target program, the flag bit is set to 0. The virtual execution flag bit serves as a basis for determining whether the instruction that triggers the exception is the instruction in the virtual execution buffer. If the flag bit is 0, it is determined that the exception is triggered by the single-step handling procedure, and step 603 needs to be performed; otherwise, it is determined that the exception is triggered by the target program, and step 607 needs to be performed.

Alternatively, a determination is made about whether an EIP of the target program at the time of triggering the exception is in an EIP range at the time of virtual execution; if so, it is determined that the exception is triggered by a single-step handling procedure, and step 603 needs to be performed; while if not, it is determined that the exception is triggered by the target program, and step 607 needs to be performed.

The exception herein is an exception that possibly occurs in the running process of the system and is different from the designated page attribute fault, and the designated page attribute fault in this embodiment of the present disclosure is caused by the modification of the page attribute.

603. Modify the extended instruction pointer of the target program at the time of triggering the exception to an original extended instruction pointer of the target program.

The EIP of the target program at the time of triggering the exception herein is the EIP of the target program at the time of virtual execution. The EIP of the target program at the time of virtual execution is modified to the original EIP of the instruction pointed to by the EIP.

604. After step 603 is performed, interact with a user.

In step 603, the EIP is modified to the original EIP of the target program, so that the user knows which instruction of the target program triggers the exception.

605. After step 604 is performed, execute an exception handling function inherent in the target program.

To handle exceptions of specific codes of the target program, the programmer presets the corresponding exception handling function.

606. After step 605 is performed, modify the original extended instruction pointer of the target program to the extended instruction pointer of the target program at the time of triggering the exception, and trigger step 506.

The original EIP of the target program is modified back to the EIP of the target program executed virtually when the exception occurs, and step 506 is triggered to go on executing the single-step handling procedure. In this way, the debugging device keeps the right of controlling the target program.

In this embodiment, the user handles the exception first, and then the exception handling function inherent in the target program handles the exception. Understandably, in step 602, if the instruction that triggers the exception is determined as the instruction in the virtual execution buffer, the exception handling function inherent in the target program may handle the exception directly, and then step 506 is triggered, which also enables the debugging device to keep the right of controlling the target program. Therefore, steps 603, 604, and 606 are omissible.

607. Interact with the user.

In step 602, if the instruction that triggers the exception is determined as other than the instruction in the virtual execution buffer, it is determined that the exception is triggered by the target program. In this case, the user may handle the exception first, and then the exception handling function inherent in the target program handles the exception before the execution of the target program continues.

608. After step 607 is performed, execute the exception handling function inherent in the target program.

609. After step 608 is performed, go on to execute the target program.

A debugging device in an embodiment of the present disclosure is described hereunder in detail.

As shown in FIG. 7, an embodiment of a debugging device in an embodiment of the present disclosure includes:
a first modifying module 701, configured to modify a fault handling function address corresponding to a page attribute fault in an interrupt descriptor table of a system processor to a user-defined fault handling function address;
an obtaining module 702, configured to obtain current information of a target program when a designated page attribute fault occurs in the target program;
a first storing module 703, configured to store the obtained current information into a virtual execution buffer corresponding to a current thread;
a second storing module 704, configured to push the current information in the virtual execution buffer corresponding to the current thread into a stack;
a first determining module 705, configured to: determine whether an extended instruction pointer of the target program matches a preset breakpoint address of a faulty page; if the matching succeeds, trigger an interacting module to perform relevant operations; otherwise, trigger a copying module to perform relevant operations;
the interacting module 706, configured to interact with a user;
the copying module 707, configured to copy-construct an instruction, pointed to by the extended instruction pointer of the target program, to the virtual execution buffer; and
an executing module 708, configured to pop the current information out of the stack, execute the instruction in the virtual execution buffer, and trigger the first determining module to perform relevant operations.

The working principles of the debugging device in this embodiment are as follows:

First, the first modifying module 701 modifies the fault handling function address corresponding to the page attribute fault in the IDT of the system processor, and modifies the page attribute of the page of the preset breakpoint. When the target program runs to this page, the page attribute fault occurs, and the target program jumps to execute the user-defined fault handling function. In this way, the debugging device obtains the right of controlling the target program.

Afterward, the target program runs. When the designated page attribute fault occurs in the target program, which causes the debugging device to obtain the right of controlling the target program, the obtaining module 702 obtains the current information, the first storing module 703 stores the current information into the virtual execution buffer corresponding to the current thread, and the second storing module 704 imports the current information from the buffer and pushes the current information into the stack.

After the second storing module 704 pushes the current information into the stack, the first determining module 705 performs relevant operations to check whether the target program runs to the breakpoint location. If the first determining module 705 determines that the matching succeeds, it is determined that the target program runs to the breakpoint location, and the interacting module interacts with the user so that the user can debug the target program; otherwise, the copying module copy-constructs the instruction, the executing module executes the instruction, and then the first determining module 705 is triggered to perform relevant operations until the target program runs to the breakpoint location.

In this embodiment, the fault handling function address corresponding to the page attribute fault is modified so that the debugging device can capture the right of controlling the target program when the page attribute fault occurs in the target program; after capturing the control right, the debugging device stores the current information into the buffer corresponding to the current thread and pushes the current information into the stack, and then copy-constructs and executes the instruction of the target program; therefore, when the target program runs to the preset breakpoint location, the system interacts with the user. In this way, the user debugs the target program covertly without modifying the codes of the target program.

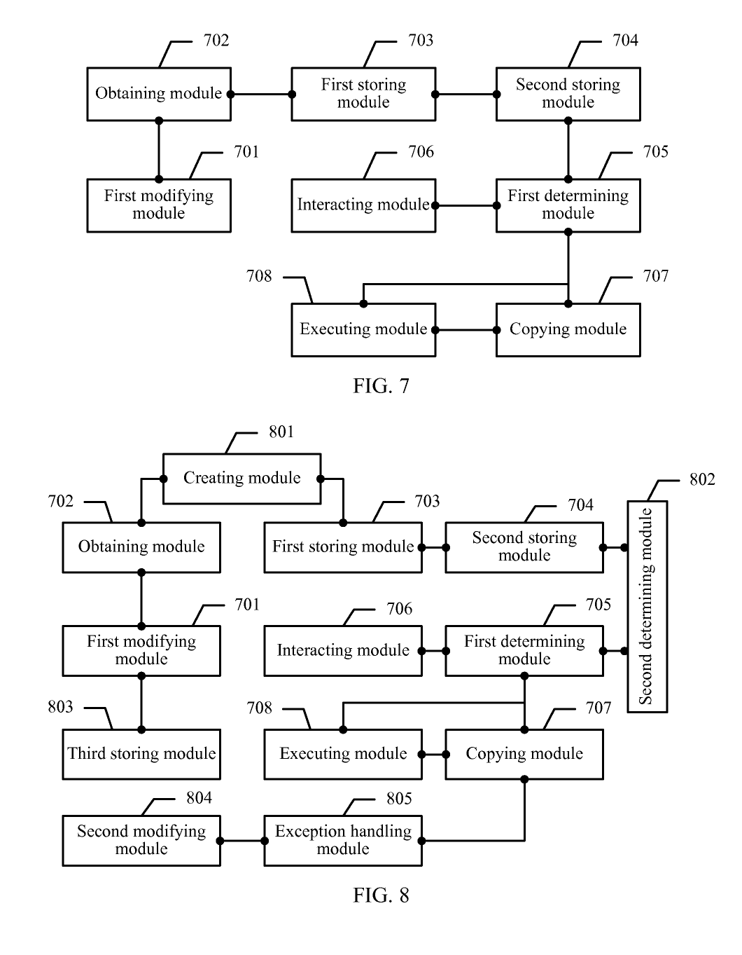

As shown in FIG. 8, compared with the embodiment in FIG. 7, another embodiment of a debugging device in an embodiment of the present disclosure further includes:
a creating module 801, configured to: after the obtaining module 702 performs relevant operations, determine whether the current thread has a corresponding virtual execution buffer; if no corresponding virtual execution buffer exists, create a virtual execution buffer corresponding to the current thread, and trigger the first storing module 703 to perform relevant operations; and if the corresponding virtual execution buffer exists, trigger the first storing module 703 to perform relevant operations;
a second determining module 802, configured to: before the first determining module 705 performs relevant operations, determine whether the extended instruction pointer of the target program goes beyond a faulty page range; and if not, trigger the first determining module 705 to perform relevant operations;
a third storing module 803, configured to store the modified fault handling function address after the first modifying module 701 performs relevant operations;
a second modifying module 804, configured to modify an exception dispatch function inherent in the system to a user-defined exception dispatch function; and
an exception handling module 805, configured to: when an executed instruction of the target program triggers an exception, determine whether the instruction is an instruction in the virtual execution buffer; and if so, execute an exception handling function inherent in the target program, and trigger the copying module 707 to perform relevant operations.

The working principles of the debugging device in this embodiment are as follows:

The first modifying module 701 modifies the fault handling function address corresponding to the page attribute fault in the IDT of the system processor. The second modifying module 804 modifies the exception dispatch function inherent in the system to the user-defined exception dispatch function. The third storing module 803 stores the modified fault handling function address after the first modifying module 701 performs relevant operations.

Afterward, the target program runs. When the designated page attribute fault occurs in the target program, which causes the debugging device to obtain the right of controlling the target program, the obtaining module 702 obtains the current information. If determining that the current thread has no corresponding virtual execution buffer, the creating module 801 creates a virtual execution buffer corresponding to the current thread, and triggers the first storing module 703 to store the obtained current information into the buffer; otherwise, the creating module triggers the first storing module 703 to store the obtained current information into the virtual execution buffer corresponding to the current thread, and the second storing module 704 imports the current information from the virtual execution buffer corresponding to the current thread and pushes the current information into the stack.

After the second storing module 704 pushes the current information into the stack, the second determining module 802 determines whether the extended instruction pointer of the target program goes beyond the faulty page range; if not, the first determining module 705 is triggered to perform relevant operations to check whether the target program runs to the breakpoint location. If the first determining module 705 determines that the matching succeeds, it is determined that the target program runs to the breakpoint location, and the interacting module 706 interacts with the user so that the user can debug the target program; otherwise, the copying module 707 copy-constructs the instruction, and the executing module 708 executes the instruction, and then the second determining module 802 is triggered to perform relevant operations until the target program runs to the breakpoint location.

When an executed instruction of the target program triggers an exception, the exception handling module 805 determines whether the instruction is an instruction in the virtual execution buffer; and if so, executes an exception handling function inherent in the target program, and triggers the copying module 707 to perform relevant operations.

Persons of ordinary skill in the art understand that all or part of the steps in various methods in the foregoing embodiments may be implemented by a program instructing relevant hardware. The program may be stored in a computer readable storage medium, and the storage medium may be a ROM, a RAM, a magnetic disk, or a CD-ROM.

The debugging method and the debugging device provided in the embodiments of the present disclosure are detailed above. Although the principle and implementation of the present disclosure are described with reference to the exemplary embodiments, the embodiments are only intended to help understand the method and core idea of the present disclosure. In addition, with respect to the implementation and applicability of the present disclosure, modifications and variations may be made by persons of ordinary skill in the art according to the idea of the present disclosure. Therefore, the specification shall not be construed as a limitation on the present disclosure.

What is claimed is:

1. A debugging method, comprising:
modifying a fault handling function address corresponding to a page attribute fault in an interrupt descriptor table of a system processor to a user-defined fault handling function address;
obtaining current information of a target program when a designated page attribute fault occurs in the target program;
storing the obtained current information into a virtual execution buffer corresponding to a current thread;
pushing the current information in the virtual execution buffer into a stack;
determining whether an extended instruction pointer of the target program matches a preset breakpoint address of a faulty page;
interacting with a user when the extended instruction pointer of the target program matches the preset breakpoint address of the faulty page;
copy-constructing an instruction, pointed to by the extended instruction pointer of the target program, to the virtual execution buffer corresponding to the current thread when the extended instruction pointer of the target program does not match the preset breakpoint address of the faulty page; and
popping the current information out of the stack, executing the instruction in the virtual execution buffer, and repeating the determination about whether the extended instruction pointer of the target program matches the preset breakpoint address.

2. The method according to claim 1, wherein:
before storing the obtained current information into the virtual execution buffer corresponding to the current thread, the method further comprises:
determining whether the current thread has a corresponding virtual execution buffer;
if no corresponding virtual execution buffer exists, creating a virtual execution buffer corresponding to the current thread, and triggering storing of the obtained current information into the created virtual execution buffer corresponding to the current thread; and
if the corresponding virtual execution buffer exists, triggering storing of the obtained current information into the existing virtual execution buffer corresponding to the current thread.

3. The method according to claim 1, wherein:
before determining whether the extended instruction pointer of the target program matches the preset breakpoint address of the faulty page, the method further comprises:
determining whether the extended instruction pointer of the target program goes beyond a faulty page range; and
triggering the determining of whether the extended instruction pointer of the target program matches the preset breakpoint address of the faulty page when the extended instruction pointer of the target program does not go beyond the faulty page range.

4. The method according to claim 1, wherein:
after modifying the fault handling function address corresponding to the page attribute fault to the user-defined fault handling function address, the method further comprises:
storing the modified fault handling function address.

5. The method according to claim 1, wherein:
while the current information of the target program is obtained, the preset breakpoint address of the faulty page of the target program is obtained, and stored together with the current information into the virtual execution buffer corresponding to the current thread; and
determining whether the extended instruction pointer of the target program matches the preset breakpoint address of the faulty page comprises:
determining whether the extended instruction pointer of the target program matches the preset breakpoint address in the virtual execution buffer corresponding to the current thread.

6. The method according to claim 1, further comprising:
modifying an exception dispatch function inherent in a system to a user-defined exception dispatch function;
when an executed instruction of the target program triggers an exception, determining whether the executed instruction is in the virtual execution buffer; and
when the executed instruction is in the virtual execution buffer, executing an exception handling function inherent in the target program, and triggering copy-constructing of the executed instruction, pointed to by the extended instruction pointer of the target program, to the virtual execution buffer.

7. The method according to claim 6, wherein:
before executing the exception handling function inherent in the target program, the method further comprises:
modifying the extended instruction pointer of the target program at the time of occurrence of the exception to an original extended instruction pointer of the target program, and triggering executing of the exception handling function inherent in the target program; and
after executing the exception handling function inherent in the target program and before copy-constructing the instruction, pointed to by the extended instruction pointer of the target program, to the virtual execution buffer, the method further comprises:
modifying the original extended instruction pointer of the target program to the extended instruction pointer of the target program at the time of occurrence of the exception.

8. A debugging device, comprising:
a first modifying module, configured to modify a fault handling function address corresponding to a page attribute fault in an interrupt descriptor table of a system processor to a user-defined fault handling function address;
an obtaining module, configured to obtain current information of a target program when a designated page attribute fault occurs in the target program;
a first storing module, configured to store the obtained current information into a virtual execution buffer corresponding to a current thread;
a second storing module, configured to push the current information in the virtual execution buffer corresponding to the current thread into a stack;
a first determining module, configured to: determine whether an extended instruction pointer of the target program matches a preset breakpoint address of a faulty page; trigger an interacting module to perform relevant operations when the extended instruction pointer of the target program matches the preset breakpoint address of the faulty page; trigger a copying module to perform relevant operations when the extended instruction pointer of the target program does not match the preset breakpoint address of the faulty page;
the interacting module, configured to interact with a user;
the copying module, configured to copy-construct an instruction, pointed to by the extended instruction pointer of the target program, to the virtual execution buffer; and
an executing module, configured to pop the current information out of the stack, execute the instruction in the virtual execution buffer, and trigger the first determining module to perform relevant operations.

9. The device according to claim 8, further comprising:
a creating module, configured to: after the obtaining module performs relevant operations, determine whether the current thread has a corresponding virtual execution buffer; if no corresponding virtual execution buffer exists, create a virtual execution buffer corresponding to the current thread, and trigger the first storing module to perform relevant operations; and if the corresponding virtual execution buffer exists, trigger the first storing module to perform relevant operations.

10. The device according to claim 8, further comprising:
a second determining module, configured to: before the first determining module performs relevant operations, determine whether the extended instruction pointer of the target program goes beyond a faulty page range; and trigger the first determining module to perform relevant operations when the extended instruction pointer of the target program does not go beyond the faulty page range.

11. The device according to claim 8, further comprising:
a third storing module, configured to store the modified fault handling function address after the first modifying module performs relevant operations.

12. The device according to claim 8, further comprising:
a second modifying module, configured to modify an exception dispatch function inherent in a system to a user-defined exception dispatch function; and
an exception handling module, configured to: when an executed instruction of the target program triggers an exception, determine whether the executed instruction is in the virtual execution buffer; and when the executed instruction is in the virtual execution buffer, execute an exception handling function inherent in the target program, and trigger the copying module to perform relevant operations.
